(19) United States
(12) Patent Application Publication
(10) Pub. No.: US 2008/0170228 A1
(43) Pub. Date: Jul. 17, 2008

(54) Method and apparatus for wafer level calibration of imaging sensors

(75) Inventor: Jutao Jiang, Boise, ID (US)

Correspondence Address: DICKSTEIN SHAPIRO LLP, 1825 EYE STREET, NW, WASHINGTON, DC, 20006, US

(73) Assignee: MICRON TECHNOLOGY, INC.

(21) Appl. No.: 11/653,857

(22) Filed: Jan. 17, 2007

(51) Int. Cl. G01N 21/25; G06F 19/00; H04N 5/76

(52) U.S. Cl. 356/416; 702/1; 348/231.99

(57) ABSTRACT

Methods and apparatuses for wafer level calibration of imaging sensors and for imaging sensors that have been calibrated at the wafer level. The quantum efficiency spectrum measurement is calculated for calibration pixels (or other region of interest) using spatially separated monochromatic light having a spectral range. The results of the quantum efficiency spectrum measurement are stored, for example in anti-fuse memory cells on the imaging sensor. An imaging system, such as a camera, utilizes an imaging device with the calibrated imaging sensor.

### FIELD OF THE INVENTION

The embodiments described herein relate generally to imaging devices and, more specifically, to a method and apparatus for calibration of imaging sensors employed in such devices.

### BACKGROUND OF THE INVENTION

Solid state imaging devices, including charge coupled devices (CCD), CMOS imaging devices, and others, have been used in photo imaging applications. A solid state imaging device circuit includes a focal plane array of pixel cells or pixels, each one including a photosensor, which may be a photogate, photoconductor, or a photodiode having a doped region for accumulating photo-generated charge. For CMOS imaging devices, each pixel has a charge storage region, formed on or in the substrate, which is connected to the gate of an output transistor that is part of a readout circuit. The charge storage region may be constructed as a floating diffusion region. In some CMOS imaging devices, each pixel may further include at least one electronic device such as a transistor for transferring charge from the photosensor to the storage region and one device, also typically a transistor, for resetting the storage region to a predetermined charge level prior to charge transference.

In a CMOS imaging device, the active elements of a pixel perform the necessary functions of: (1) photon to charge conversion; (2) accumulation of image charge; (3) resetting the storage region to a known state; (4) transfer of charge to the storage region; (5) selection of a pixel for readout; and (6) output and amplification of a signal representing pixel charge. Photo charge may be amplified when it moves from the initial charge accumulation region to the storage region. The charge at the storage region is typically converted to a pixel output voltage by a source follower output transistor.

CMOS imaging devices of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, assigned to Micron Technology, Inc., which are hereby incorporated by reference in their entirety.

The quantum efficiency (QE) spectrum of the pixels utilized in an imaging device is an important parameter regarding an imaging device's performance. The quantum efficiency of a pixel is defined as the ratio between photoelectrons generated by a pixel's photosensor and the total number of incident photons. Based on the quantum efficiency spectrum, many important parameters of an imaging device and the pixels comprising that imaging device can be derived or calculated, such as pixel sensitivity, cross-talk, color rendition accuracy, and a color correction matrix, etc. FIG. 1 shows an example quantum efficiency spectrum curve for an imaging device that uses a red, green, blue (RGB) Bayer pattern color filter array (CFA). The imaging device's quantum efficiency is calculated for all of the pixels of the four color channels, blue 1, greenblue 2 (green pixels in the same row as blue pixels), greenred 3 (green pixels in the same row as red pixels), and red 4.

During the probe testing of CMOS imaging devices, bandgap circuitry adjustments and master current reference adjustments are performed on a part-by-part basis because current reference designs typically depend on the absolute value of parameters that may vary from part to part. This type of “electrical trimming” can guarantee that the imaging device's electrical properties will be within the specified design limits. The imaging device's optical characteristics, such as spectral response, cross-talk, etc., can also vary with the imaging device fabrication process. However, calibration of these optical characteristics is not typically performed for imaging devices during probe testing because current quantum efficiency spectrum measurement methods are too time consuming to be performed on a part-by-part basis.

Optical characteristics of a CMOS imaging device are mainly represented by the quantum efficiency spectrum of its pixels. On system-on-a-chip (SOC) type imaging devices, a color pipeline's parameters are based on a bench test of several imaging device samples. All of the imaging devices in a production lot will have the same set of parameters. However, the quantum efficiency spectrum curve can vary greatly from die to die on the same wafer or from lot to lot. The implications of the quantum efficiency spectrum variance might not significantly impact low-end CMOS imaging devices, such as imaging devices designed for mobile applications. However, for high-end imaging devices, such as imaging devices designed for digital still cameras (DSC) or digital single-lens reflex (DSLR) cameras, the implications of the quantum efficiency spectrum variance may be significant. Currently, digital single-lens reflex camera manufacturers spend a significant amount of time and money calibrating color processing parameters based on an imaging device's quantum efficiency spectrum. Therefore, a method of efficiently providing quantum efficiency spectrum data for each die that would allow for adjustments of a color processing pipeline's parameters is needed.

The measurement of a quantum efficiency spectrum curve for an imaging device is usually a time consuming procedure. A conventional quantum efficiency measurement test setup is illustrated in FIG. 2A. A broadband light source 10 provides continuous wavelength light 12 across a range (e.g., between 390 nm and 1100 nm). The broadband light 12 is passed through a grating 22 of a grating based monochromator 20 to produce monochromatic light 24. A controllable mechanical shutter 30 inside the monochromator 20 can block the monochromatic light beam 24 to measure dark offset. The monochromatic light 24 coming out of an exit slit 40 enters an integrating sphere 50.

The imaging sensor under test 60 is placed at a specific distance from the exit port 70 of integrating sphere 50. The photon density (photons/μm²-second) at the imaging sensor surface plane can be calibrated by an optical power meter (not shown) for each wavelength. At each wavelength of light, 30 frames of image data can be captured from imaging sensor 60. Temporal noise can be reliably measured with approximately 30 frames or more of image data. Typically, only a small window of pixels in the center of the imaging sensor's 60 pixel array is chosen for the quantum efficiency calculation due to a phenomenon known as microlens shift. This small window is called the region of interest (ROI). The total electrons generated for a specific color pixel (e.g., greenred, red, blue, and greenblue) can be calculated as:

Nₑ=(S/nₜₑₘₚ)² (1)

where S is the mean signal and nₜₑₘₚ is the mean temporal noise for the color pixels inside the region of interest. The mean signal can be expressed as:

$$S = \frac{1}{XYN} {\sum }_{n = 1}^{N} {\sum }_{x = 0}^{X - 1} {\sum }_{y = 0}^{Y - 1} {p}_{n} ( x , y ) \qquad ( 1.1 )$$

where N is the number of frames; XY is the number of pixels of a particular color channel in each frame; n, x, and y are integer indexes covering the range:

1≦n≦N;0≦×≦(X−1);0≦y≦(Y−1);

and pₙ (x, y) represents the pixel signal of location (x,y) of the nₜₕ frame. The partial signal average (average over frames) for a pixel at location (x,y) can be expressed as:

$$\overline{p} ( x , y ) = \frac{1}{N} {\sum }_{n = 1}^{N} {p}_{n} ( x , y ) . \qquad \text{(1.2)}$$

Then the mean temporal noise can expressed as:

$${n}_{temp} = {[ \frac{1}{XYN} {\sum }_{n = 1}^{N} {\sum }_{x = 0}^{X - 1} {\sum }_{y = 0}^{Y - 1} {( {p}_{n} ( x , y ) - \overline{p} ( x , y ) )}^{2} ]}^{1 / 2} . \qquad ( 1.3 )$$

Since the incident photons density for each wavelength is known, the quantum efficiency at each wavelength can be calculated as:

$$η = \frac{{N}_{e}}{{n}_{photon} \cdot {d}^{2} \cdot {t}_{int}} \qquad ( 2 )$$

where nₚₕₒₜₒₙ is the photon density in the unit of “photons/μm²-second,” d is the pixel pitch in the unit of “μm,” and tint is the pixel integration time in the unit of “second.” As shown in the flowchart of FIG. 2B, by repeating the above procedure for each wavelength and for each color pixel, the whole quantum efficiency spectrum of the imaging sensor 60 can be acquired. That is, once the grating is set (step 1010) and the region of interest is illuminated (step 1020), the quantum efficiency is calculated as shown above. After calculating the quantum efficiency spectrum measurement for all pixels of a given color channel within the region of interest (step 1030), a determination must be made if the quantum efficiency for all color channels at that wavelength of light have been calculated (step 1040). If all of the color channels have not been calculated, the next color channel must be calculated (step 1030). If all of the color channels have been calculated, then a determination must be made if all wavelengths for a given resolution of the quantum efficiency spectrum have been calculated (step 1050). For example, using 10 nm resolution for the quantum efficiency spectrum, 72 wavelength points need to be measured (from 390 nm to 1100 nm) for each color pixel. Since most monochromators are based on a rotating grating driven by an electric motor, changing from one wavelength to another wavelength (step 1010) is a relatively slow process. Once a determination has been made that all wavelengths have been calculated (step 1050), the quantum efficiency spectrum measurement test is complete (step 1060). Using current methods, like the one just described, the entire quantum efficiency spectrum test for one imaging sensor 60 can take more than one hour.

Due to the time consuming nature of quantum efficiency spectrum tests, the test is often only performed for a single imaging device. For future high end imaging devices, such as imaging devices designed for digital still cameras or digital single-lens reflex cameras, quantum efficiency spectrum data for each individual die might be required for calibration purposes, such as color correction derivation, etc. In addition, for any new color filter array or microlens process optimization, quantum efficiency spectrum data across the whole wafer might provide valuable information. With the current quantum efficiency spectrum measurement method, however, it is not feasible to accomplish those tasks. Accordingly, there is a need for a quantum efficiency spectrum measurement method and a new imaging sensor that more easily enables wafer level quantum efficiency testing so that imaging device parameters can be adjusted on a part-by-part basis and in an inexpensive manner.

### BRIEF DESCRIPTION OF THE DRAWINGS

FIG. 1 illustrates an example quantum efficiency spectrum curve for a red, green, blue Bayer pattern color filter array imaging device.

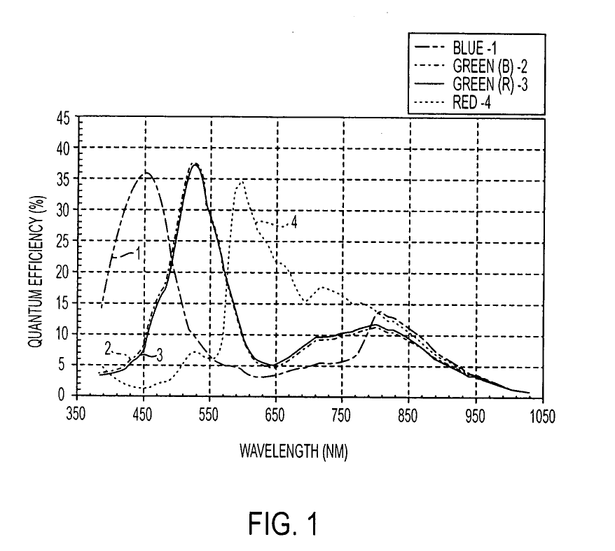

FIG. 2A illustrates a conventional quantum efficiency spectrum measurement apparatus.

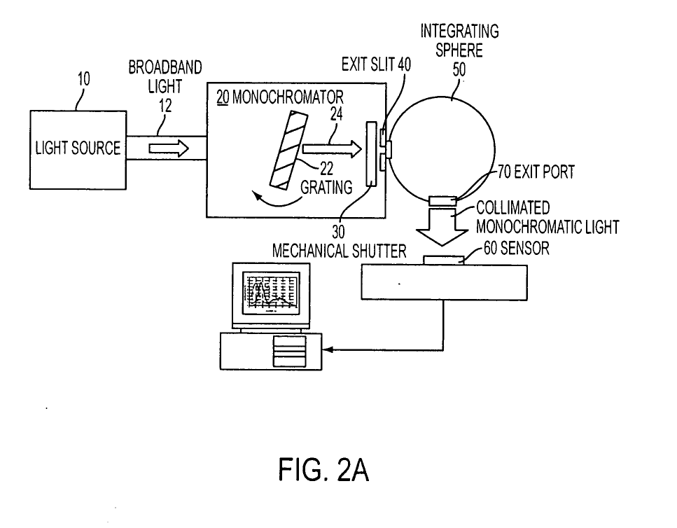

FIG. 2B illustrates a flowchart of a conventional quantum efficiency spectrum measurement.

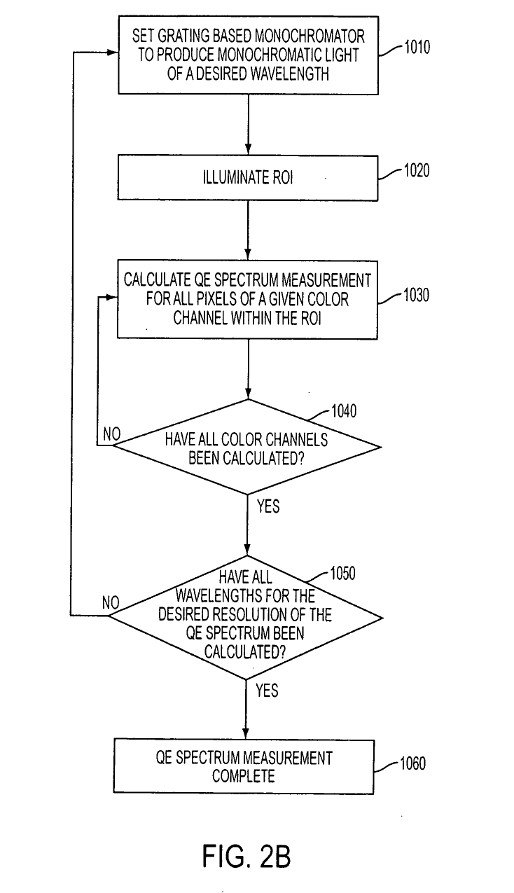

FIG. 3 illustrates a quantum efficiency spectrum measurement method based on a wedge filter.

FIG. 4A illustrates a quantum efficiency spectrum measurement method based on a wedge filter for an imaging device designed with a small chief ray angle (CRA).

FIG. 4B illustrates a flowchart of a quantum efficiency spectrum measurement based on a wedge filter for an imaging device designed with a small chief ray angle.

FIG. 5A illustrates a quantum efficiency spectrum measurement method based on a wedge filter for an imaging device designed with a large chief ray angle.

FIG. 5B illustrates a flowchart of a quantum efficiency spectrum measurement based on a wedge filter for an imaging device designed with a large chief ray angle.

FIG. 6 illustrates a quantum efficiency spectrum measurement method based on a diffractive grating.

FIG. 7 illustrates a quantum efficiency spectrum measurement method based on a prism.

FIG. 8 illustrates an example distance versus wavelength curve for a wedge filter and a diffractive grating.

FIG. 9A illustrates a top view of a CMOS imaging sensor with rows of pixels with no microlens shift and columns of anti-fuse memory cells.

FIG. 9B is a schematic circuit diagram of an anti-fuse memory cell.

FIG. 10 illustrates a top view of a CMOS imaging device with an imaging sensor with rows of pixels with no microlens shift and columns of anti-fuse memory cells under probe testing of the wafer level quantum efficiency spectrum using a wedge filter.

FIG. 11 illustrates a continuous variable neutral density filter for imaging sensor/pixel parameter measurement.

FIG. 12 shows a block diagram of an imaging device constructed in accordance with an exemplary embodiment.

FIG. 13 shows a system incorporating at least one imaging device.

FIG. 14 illustrates a block diagram of system-on-a-chip imaging device constructed in accordance with an embodiment.

FIG. 15 illustrates an exemplary sensor core.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those of ordinary skill in the art to make and use them, and it is to be understood that structural, logical, or procedural changes may be made to the specific embodiments disclosed.

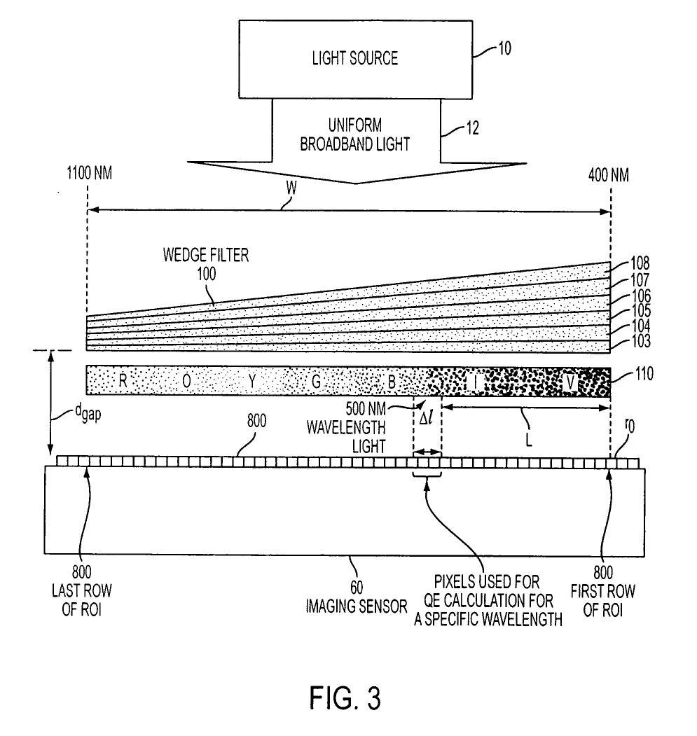

FIG. 3 illustrates a quantum efficiency spectrum measurement technique in accordance with an embodiment, which uses a wedge filter 100 as described below. A stable broadband light source 10 provides uniform illumination 12 to one side of the wedge filter 100. After passing the wedge filter 100, the broadband light 12 is decomposed into continuous spatially separated monochromatic light 110 across the width and length of the region of interest 800 of the wedge filter 100. To measure the quantum efficiency spectrum of an imaging sensor 60 with no microlens shift, the region of interest 800 of the imaging sensor 60 should be placed in a direct optical path, e.g., directly underneath, the wedge filter 100. The gap thickness, d_{gap}, between the filter 100 and imaging sensor 60 should be as small as possible to avoid mixing different wavelengths of light. If the wedge filter 100 has a smaller width or length than the width or length of the region of interest 800, an optical system (not shown), such as a lens, can be placed between the wedge filter 100 and the imaging sensor 60 to project the continuous spatially separated monochromatic light 110 across the entire width and length of the region of interest 800.

Wedge filters (i.e., “linear variable filters”) of the type discussed above have been used widely in compact spectrometers and are generally known as discussed, for example, in U.S. Pat. No. 5,872,655 and U.S. Pat. No. 4,957,371, which are hereby incorporated by reference in their entirety. A wedge filter 100 typically consists of multiple layers 103, 104, 105, 106, 107, and 108 (up to several hundreds layers) of dielectric materials with repeatable high and low indexes of refraction. For any specific location along the wedge filter 100, the wedge filter 100 basically functions as a narrow pass interference filter that only allows light with a specific wavelength to pass while blocking the rest of the light. Due to the linear thickness variation from one side of the wedge filter to other side, the passing wavelength is continuously varied. With the correct choice of material and thickness variation control, a wedge filter 100 can be fabricated to pass a specific spectral range within a specified physical width w.

Using a wedge filter 100 for the quantum efficiency spectrum measurement of an imaging sensor 60 creates spatially separated monochromatic light that can be projected onto the region of interest 800 of the imaging sensor array. Therefore, pixels at different locations “see” different wavelengths of light. This is a vast improvement over the monochromator based quantum efficiency measurement described above in which the whole pixel array “sees” the same wavelength of light and the measurement had to be repeated after the monochromator was set for each individual wavelength of light. This new method allows for quantum efficiency spectrum measurement for the whole spectral range within seconds. This method can be applied to the probe testing flow, which would allow for a quantum efficiency spectrum test for each die on a wafer.

To calculate the quantum efficiency spectrum value for a specific wavelength of a specific color pixel, the number of pixel rows receiving that specific wavelength of light needs to be determined. Referring again to FIG. 3, it should be appreciated that certain parameters should be known from the wedge filter 100 manufacturer, such as the length of the wedge filter 100; the width w of the wedge filter 100; the passing spectral range of the wedge filter 100 (e.g., 400 nm-1100 nm); and the passing wavelength versus location along the width w of the wedge filter 100. For example, using 10 nm resolution for the quantum efficiency spectrum and the known passing wavelength versus location along the width w of the wedge filter 100, it is possible to calculate both the mean wavelength within a 10 nm spectral range and the Al change in width w of the wedge filter 100 along the spectral range of the mean wavelength. For example, as shown in FIG. 3, the mean wavelength within the Δl region is 500 nm. The number of rows covered by this Δl width can be calculated as:

$${N}_{row} = \frac{Δ l}{d} \qquad ( 3 )$$

where d is the pitch of pixels on the imaging sensor 60. The physical starting row number on the imaging sensor 60 can be determined as:

$${r}_{start} = \frac{L}{d} + {r}_{0} \qquad ( 4 )$$

where r₀ is the row number for the row which is aligned with the right edge of wedge filter 100 and L is the distance between one end of the Δl region and the right edge of wedge filter 100. Assuming the continuous spatially separated monochromatic light 110 covers all of the columns of the region of interest 800, the total number of pixels covered by Δl can be expressed as:

Nₚᵢₓₑₗ=N_{row}*N_{column} (5)

where N_{column} is the total number of columns of the region of interest 800. Assuming a red, green, blue Bayer pattern color filter array is used with the imaging sensor 60 to achieve four color pixels (greenred, red, blue, and greenblue), there will be Nₚᵢₓₑₗ/4 pixels for each color channel. The mean signal and mean temporal noise for each color pixel can be respectively calculated easily from equations (1.1) and (1.3), allowing the total electrons generated for each specific color pixel to be calculated according to equation (1).

A minimum of two frames of data are required to measure the whole quantum efficiency spectrum of an imaging device to compensate for temporal noise. A more accurate reading can be achieved with more frames of data with good accuracy occurring at about twenty frames.

Prior to calculating the quantum efficiency according to equation (2) for imaging sensor 60, the photon density along the wedge filter 100 for a particular broadband light source 10 must be known. A wedge filter spectrometer may be used to calculate the photon density nₚₕₒₜₒₙ along the wedge filter 100 for a particular broadband light source 10. To calculate the photon density (in the unit of “photons/μm²-second”) of the wedge filter 100 for a particular broadband light source 10, a color or monochrome imaging sensor with known quantum efficiency spectrum is placed to receive light from the wedge filter 100. After collecting approximately 20 frames of imaging data to achieve an accurate reading, the mean signal and mean temporal noise for each color pixel can be respectively calculated easily from equations (1.1) and (1.3) and the total electrons generated inside each pixel of the imaging sensor with known quantum efficiency spectrum can be derived based on equation (1). The photon density along the wedge filter 100 for a particular broadband light source 10 can be easily derived based on equation (2). The photon density needs to be calculated for each location along the width of the wedge filter 100.

With a known photon density, the quantum efficiency spectrum values for each color pixel at a particular wavelength light can be calculated based on equation (1) and equation (2). By repeating the above procedure across the whole width of the wedge filter for pixels at different rows, a complete quantum efficiency spectrum of the imaging sensor 60 can be achieved for each color pixel. Assuming only 20 frames of imaging data are required for an accurate measurement, the newly disclosed quantum efficiency spectrum measurement of the imaging sensor 60 can be completed within seconds or faster depending on the frame rate.

Currently, most imaging devices use a shifted microlens technique to improve light collecting efficiency for pixels with a non-zero chief ray angle. To measure the quantum efficiency spectrum of imaging devices with shifted microlenses, a small portion of pixels (e.g., region of interest) in the center of array is usually selected because the microlens shift for those pixels is negligible. The quantum efficiency spectrum measurement will be performed only for pixels inside the region of interest because the larger the microlens shift, the less accurate the quantum efficiency spectrum measurement.

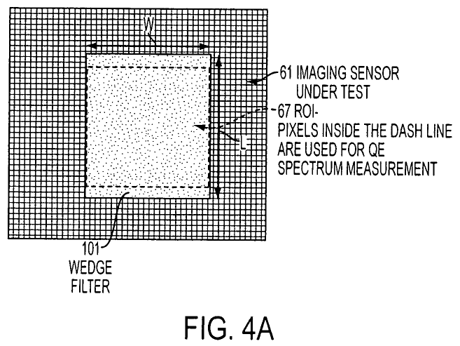

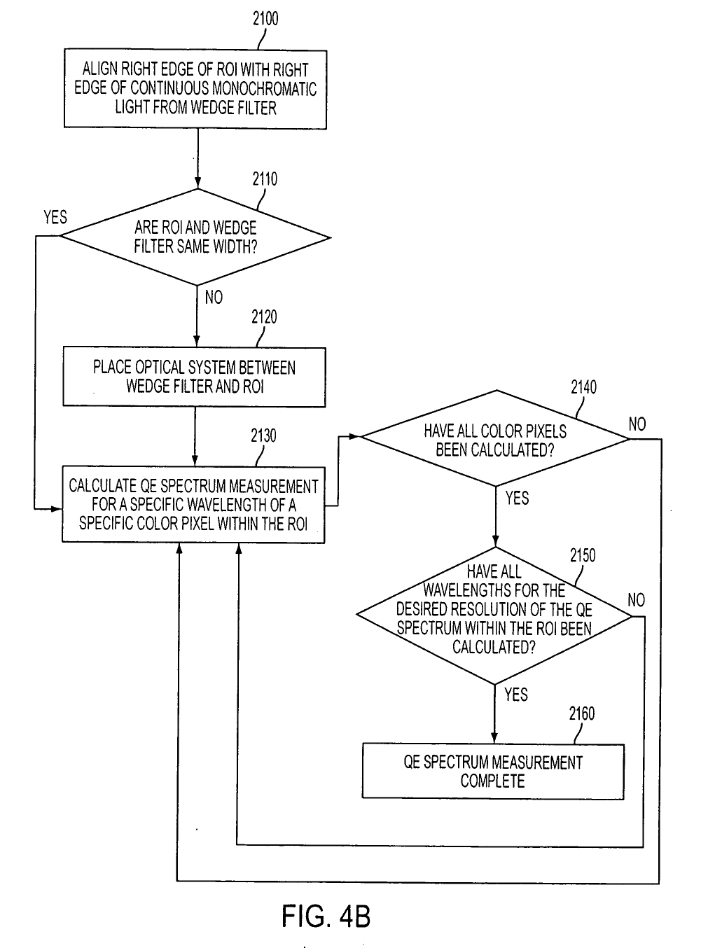

FIG. 4A illustrates an imaging sensor 61 under test where the number of pixels with a negligible microlens shift is very large, such as, for example, a large format (e.g., 6 megapixel or greater) imaging sensor with a small maximum chief ray angle (e.g., 15 degrees or less). A wedge filter 101 with a width w and having a sufficient passing spectral range (e.g., from 400 nm to 1100 nm) could be used to calculate the quantum efficiency spectrum with the measurement method described above. The width of wedge filter 101 is equal to the width of the region of interest 67 of the imaging sensor 61, represented by the dashed line in FIG. 4A. The length of the wedge filter 101 is greater than the width of the region of interest 67 of the imaging sensor 61. In the alternative, if the passing spectral range of the wedge filter 101 and the region of interest of the imaging sensor 61 are not of the same width, an optical system (not shown), such as, for example, a lens, can be placed between the wedge filter 101 and the imaging sensor 61 to project a continuous spatially separated monochromatic light across the width of the region of interest of the imaging sensor 61. The quantum efficiency spectrum of the pixels within the region of interest 67 of the imaging sensor 61 can then be easily measured in the same way as described above for an imaging sensor with no microlens shift. It should be appreciated that an optical system can also be used to project the continuous spatially separated monochromatic light along the length of the region of interest if the length of the wedge filter is smaller than the length of the region of interest 67.

FIG. 4B shows a flowchart that more clearly explains the methods shown in FIG. 4A. At step 2100, the right edge of the region of interest 67 is aligned with the right edge of the continuous spatially separated monochromatic light from the wedge filter 101. A determination (step 2110) must be made to determine if the region of interest 67 and the wedge filter 101 are the same width. If they are not the same width, an optical system is placed between the wedge filter 101 and the region of interest 67 (step 2120). At step 2130, the quantum efficiency spectrum measurement is then calculated for a specific color pixel at specific wavelength within the region of interest 67. If all color pixels have not been calculated (step 2140), then step 2130 is repeated until all color pixels have been calculated for a specific wavelength. After all color pixels have been calculated, it must be determined (step 2150) if all of the wavelengths of the desired resolution of the quantum efficiency spectrum within the region of interest 67 have been calculated. Once all of the wavelengths of the desired resolution of the quantum efficiency spectrum within the region of interest 67 have been calculated (step 2150), the entire quantum efficiency spectrum has been measured (step 2160), if not, the method continues at step 2130.

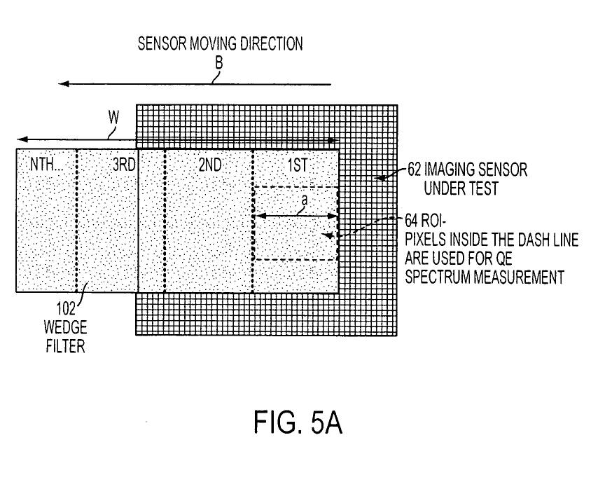

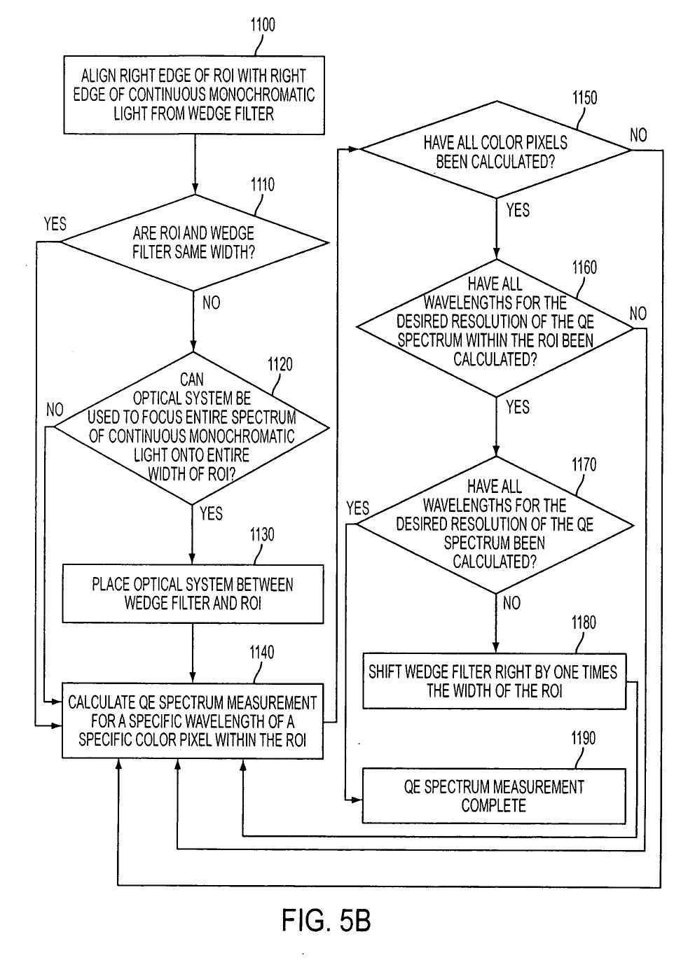

FIG. 5A illustrates an imaging sensor 62 under test where the number of pixels in the imaging sensor 62 having a negligible microlens shift is small, such as, for example, in imaging sensors for a mobile application with a very large maximum chief ray angle (e.g., greater than 15 degrees). The region of interest 64 of the imaging sensor 62, represented by the dashed lines in FIG. 5A, will be very small. The region of interest of the imaging sensor 62 is not sufficiently large for enough passing spectral range (e.g., from 400 nm to 1100 nm) to be projected onto the region of interest of the imaging sensor 62. While an optical system (not shown) could be placed between the wedge filter 102 and the imaging sensor 62, in some instances the resulting continuous spatially separated monochromatic light may be insufficient to calculate an accurate quantum efficiency spectrum measurement, such as, for example when the required distance between the wedge filter 102 and the imaging sensor 62 to fully project the passing spectral range on the region of interest 64 is so great that different wavelengths of light are mixed. Therefore, the quantum efficiency spectrum measurement can be calculated multiple times by moving the imaging sensor 62 (or the wedge filter 102) in the direction shown by arrow B. The quantum efficiency measurement will be repeated Nᵣₑₚₑₐₜ times where Nᵣₑₚₑₐₜ can be expressed as:

$${N}_{repeat} = \frac{w}{a} \qquad ( 6 )$$

where w is the total width of the wedge filter 102 and “a” is the width of the region of interest 64 of the imaging sensor 62. At each measurement position, the wavelength range measured for the quantum efficiency spectrum is:

$${λ}_{step} = \frac{{λ}_{spectral\_range}}{{N}_{repeat}} \qquad ( 7 )$$

where λ_{spectral}_{_{—}}_{range} is the passing spectral range of the wedge filter 102 along its total width w. At each measurement position, 20 frames of imaging data will be collected and the quantum efficiency spectrum for that portion of wavelength range will be calculated as described above for imaging sensors with no microlens shift.

FIG. 5B shows a flowchart that more clearly explains the methods shown in FIG. 5A. At step 1100, the right edge of the region of interest 64 (FIG. 5A) is aligned with the right edge of the continuous monochromatic light from the wedge filter 102 (FIG. 5A). A determination (step 1110) must be made to determine if the region of interest 64 and the wedge filter 102 are the same width. If they are not the same width, a determination (step 1120) must be made to determine if an optical system can be used to focus the entire spectrum of continuous spatially separated monochromatic light from the wedge filter 102 on the entire width of the region of interest 64. If an optical system is used, it is placed between the wedge filter 102 and the region of interest 64 (step 1130). At step 1140, the quantum efficiency spectrum measurement is calculated for a specific wavelength of a specific color pixel within the region of interest 64. If all color pixels have not been calculated for a specific wavelength (step 1 150), then step 1140 is repeated until all color pixels have been calculated for that specific wavelength. After all color pixels have been calculated, it must be determined (step 1160) if all of the wavelengths of the desired resolution of the quantum efficiency spectrum within the region of interest 64 have been calculated. Once all of the wavelengths of the desired resolution of the quantum efficiency spectrum within the region of interest 64 have been calculated (step 1160), it must be determined if all of the wavelengths for the desired resolution of the quantum efficiency spectrum have been calculated (step 1170). If they have not been calculated, the wedge filter can be shifted the width of the region of interest to the right (step 1180). The above process (steps 1140 to 1180) can be repeated until the entire quantum efficiency spectrum has been measured (step 1190).

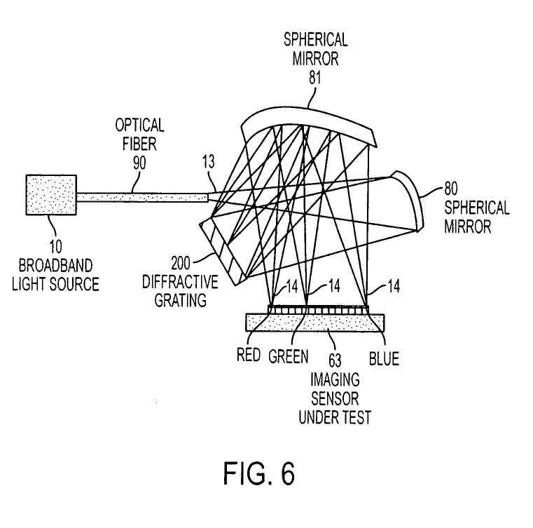

While the above quantum efficiency measurement methods have been described based on a wedge filter, any known method to spatially separate light may be used, such as e.g., a diffractive grating or a prism. One method of spatially separating light using a diffractive grating 200 is shown in FIG. 6. Light 13 is guided from a broadband light source 10, through an optical fiber 90, and illuminates a spherical mirror 80. The diffused broadband light 13 from the optical fiber 90 is collimated by the spherical mirror 80 and is projected onto a diffractive grating 200. A second spherical mirror 81 then focuses the spectrum of spatially separated monochromatic light 14 from the diffractive grating 200 onto the imaging sensor 63.

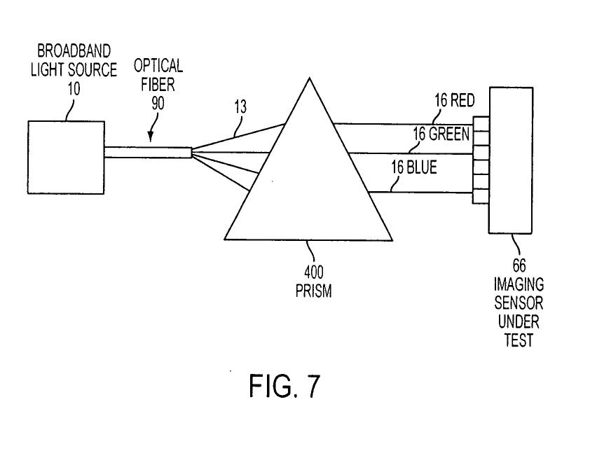

Additionally as shown in FIG. 7, a prism 400 may be used to spatially separate light. Light 13 is guided from a broadband light source 10, through an optical fiber 90, and illuminates a prism 400. The diffused broadband light 13 is spatially separated by the prism 400 to produce a spectrum of spatially separated monochromatic light 16 which is focused onto the imaging sensor 66.

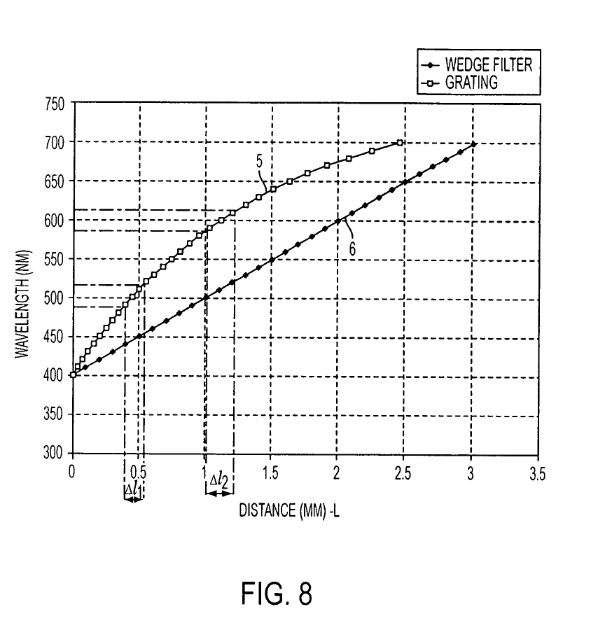

The quantum efficiency spectrum derivation procedure is the same as described above for the wedge filter for both the diffractive grating 200 and the prism 400. However, for diffractive gratings and prisms, the distance L (Eqn. 4) versus wavelength relationship is not linear. FIG. 8 shows an example distance L versus wavelength for a diffractive grating curve 5 and a linear wedge filter curve 6. Prior to calculating the quantum efficiency spectrum measurement with a diffractive grating filter, the distance versus wavelength curve at each wavelength should be calibrated with an imaging device with a known quantum efficiency spectrum. Based on this curve, the Δl (Eqn. 3) for each wavelength used for quantum efficiency spectrum measurement can be determined. The Δl might vary for each wavelength, for example as shown in FIG. 8, Δl might be 0.15 mm (Δl,) for the distance covered by the 500 nm mean wavelength and Al might be 0.20 mm (Δl₂) for the distance covered by the 600 nm mean wavelength. In contrast, the Al will be always same for each wavelength of light for the wedge filter.

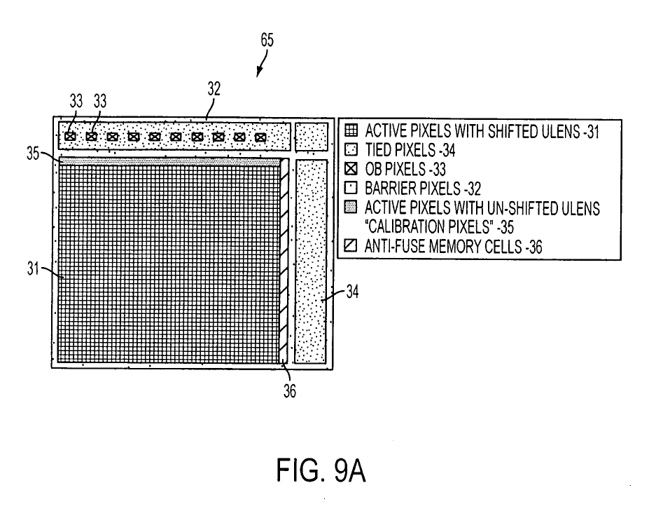

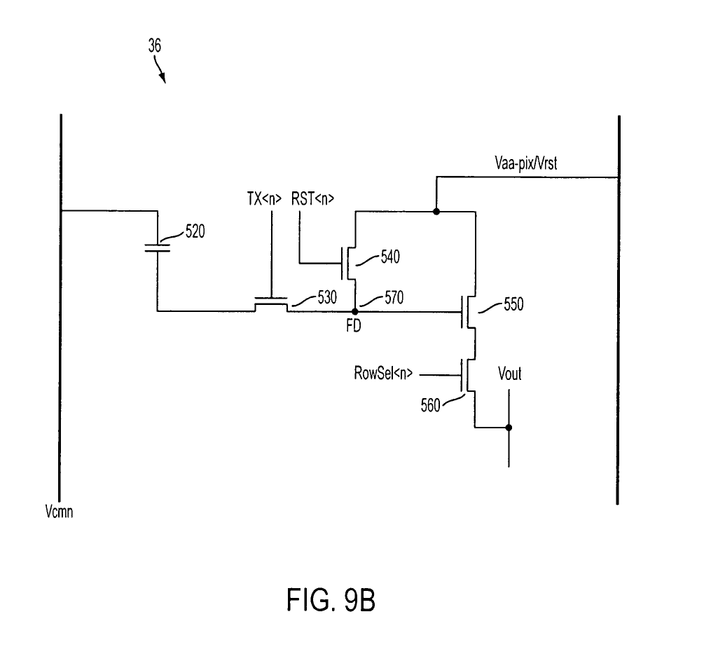

To more readily utilize the newly disclosed quantum efficiency measurement method described above, a traditional CMOS imaging device may be modified to include an array of “calibration pixels” (active pixels with no microlens shift) and an array of anti-fuse memory cells. Referring now to FIG. 9A, as in a traditional CMOS imaging device, the illustrated embodiment of imaging sensor 65 contains active pixels 31 with shifted microlenses for imaging purposes. The optical black (OB) pixel arrays 33 and tied pixels 34 (pixels in which the photodiode is tied to a fixed voltage, as presented in published U.S. Patent Application 2006-0192864, incorporated herein by reference) are used for black level calibration, dark current compensation, and row noise correction purposes. Two new types of pixels are added to the traditional CMOS imaging device: some number of rows of calibration pixels 35 at the top of the active pixel array 31 and some number of columns of anti-fuse memory cells 36 at the left side of the active pixel array 31.

Anti-fuse memory cells 36 are memory cells based on a four-transistor CMOS pixel element as shown in FIG. 9B. Anti-fuse memory cell 36 includes an anti-fuse element 520, a transfer transistor 530, a reset transistor 540, a source-follower transistor 550, a row select transistor 560, and a storage region 570, for example, formed in a semiconductor substrate as a floating diffusion region. An anti-fuse element 520 may exist in one of two states. In its initial state (“un-programmed”) the anti-fuse element 520 functions as an open circuit, preventing conduction of current through the anti-fuse element 520. Upon application of a high voltage or current, the anti-fuse element 520 is converted to a second state (“programmed”) in which the anti-fuse element 520 functions as a line of connection permitting conduction of a current. Anti-fuse memory cells 36 are presented in U.S. patent application Ser. Nos. 11/600,202; 11/600,203; and 11/600,206, incorporated herein by reference.

A minimum of two rows of calibration pixels 35 with no microlens shift should be added to the CMOS imaging sensor having a red, gree, blue Bayer pattern color filter array so that all pixel color channels are represented in the rows of calibration pixels 35. As size is a factor in imaging devices, the number of rows added for testing should be calculated based on reliability/accuracy needs versus space efficiency. On average, a minimum of ten rows of calibration pixels 35 is preferred to provide reliability while also maintaining efficiency. In an imaging sensor 65 having a red, green, blue Bayer pattern color filter array, the rows of calibration pixels 35 will have a normal red, green, blue Bayer pattern color filter array. It should be understood that the location of the array of calibration pixels 35 can vary from FIG. 9A and can be placed anywhere on the imaging sensor 65. The quantum efficiency spectrum curve for the imaging sensor 65 can then be derived by testing the array of calibration pixels 35 according to the method described above. The rows of calibration pixels 35 will function as the region of interest.

The anti-fuse memory cells 36 shown in FIG. 9A can be used to store the results of the quantum efficiency spectrum measurements. For example, for high-end core imaging sensors or stand-alone imaging sensors, the quantum efficiency spectrum data can be saved directly into an imaging device by utilizing the anti-fuse memory cells 36 of the imaging sensor 65, an imaging device's laser fuses, or other memory. Due to the large amount of data representing the quantum efficiency spectrum, the anti-fuse memory cells 36 of the imaging sensor 65 are well suited for this application, however any known method of storing the quantum efficiency spectrum measurement, whether on-chip or off-chip, may be used. The quantum efficiency spectrum data can then be accessed by a module or camera manufacturer for final image processing parameter calibration and optimization.

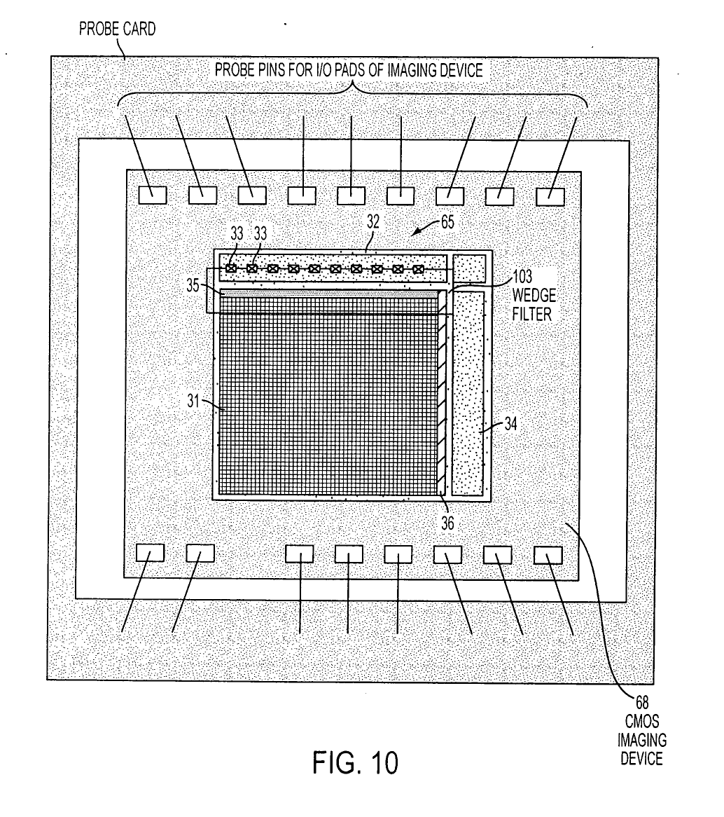

If the imaging device under test is a high-end system-on-a-chip imaging device, some of the system-on-a-chip imaging device's color pipeline parameters, such as the color correction matrix, can be adjusted during probe testing after the quantum efficiency spectrum measurement. The adjusted values can be then be saved in memory, for example into the imaging device's laser fuses or the imaging sensor's 65 on-chip anti-fuse memory cells 36 (FIG. 9A). FIG. 10 further illustrates the imaging sensor 65 of FIG. 9A in an imaging device 68 undergoing quantum efficiency spectrum measurement with a wedge filter 103 during probe testing.

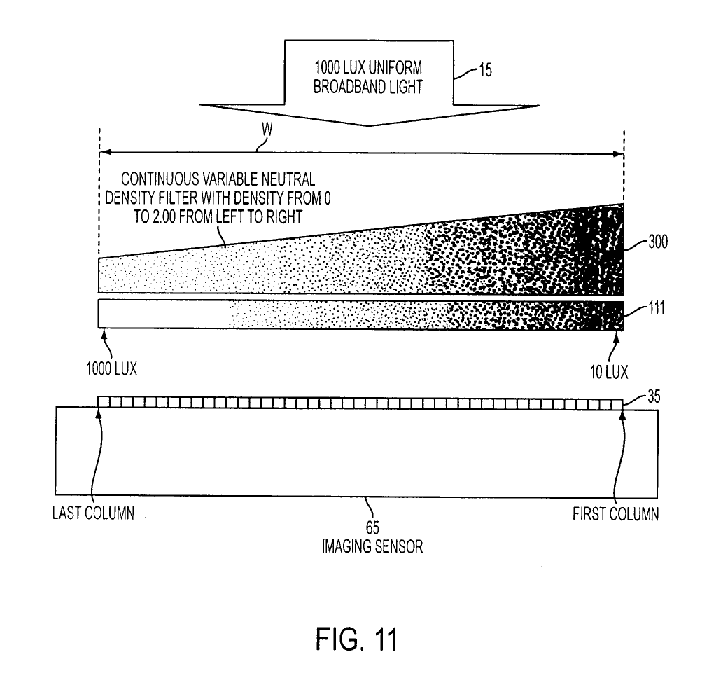

Referring now to FIG. 11, the calibration pixels 35 also allow for imaging sensor/pixel parameter measurement using a continuous variable neutral density filter 300. Continuous variable neutral density filters 300 are known in the art and are commercially available, such as the continuous variable density beamsplitter from Edmund Optics, Inc. It should be appreciated that the continuous variable neutral density filters 300 can be of any shape, such as, for example, planer or wedge. A 1000 lux uniform broadband light 15 is passed through a continuous variable neutral density filter 300. The filter 300 modulates the light intensity continuously across the width W of the filter 300. For example, after passing through the filter 300, the 1000 lux uniform broadband light 15 will become a linear variable light 111 from 1000 lux to 10 lux. By projecting continuous variable intensity light 111 onto the rows of calibration pixels 35, many other imaging sensor/pixel parameters can be measured quickly on the wafer level by collecting approximately thirty frames of data. It should be appreciated that the number of frames collected depends on what pixel parameters are to be measured. The imaging sensor/pixel parameters can include, but are not limited to, pixel well capacity; linearity of pixel signal response; transaction factor (in the unit of “electron/digital code”) at different gain settings of the imaging device; and photon transfer curve. The result of these parameters can be saved in memory, for example into the imaging device's 65 laser fuses or the imaging sensor's 65 anti-fuse memory cells 36 (shown on FIG. 9A), for advanced imaging processing/calibration/correction purposes.

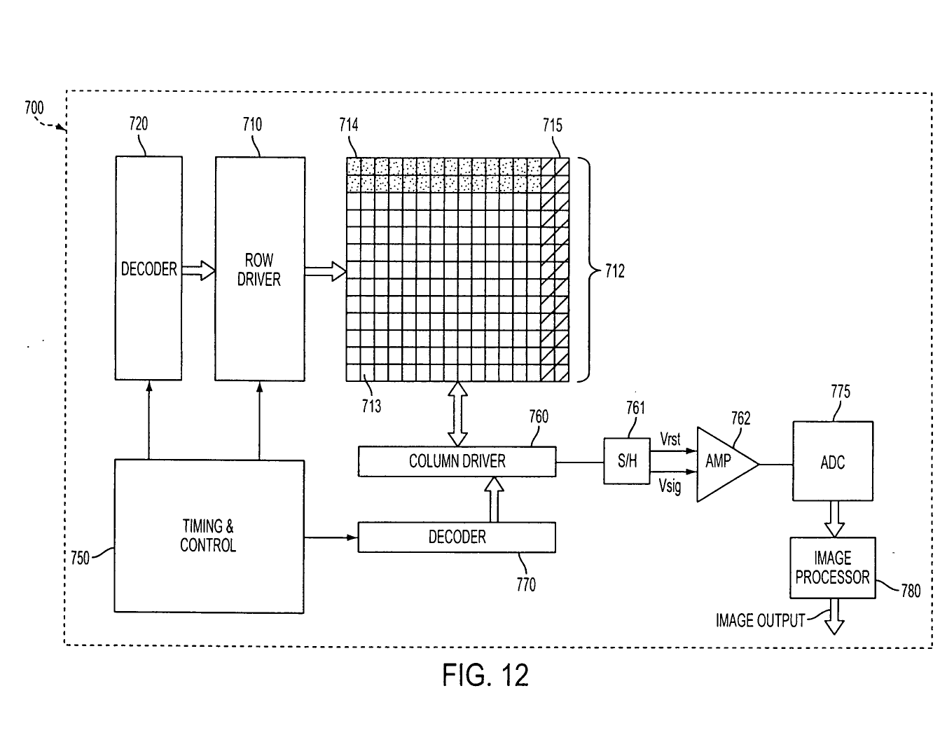

FIG. 12 illustrates a partial top-down block diagram view of an imaging device 700 where an imaging sensor 712 is formed with an active pixel array 713, calibration pixel rows 714, and anti-fuse memory cell colunms 715. FIG. 12 illustrates a CMOS imaging device and associated readout circuitry, but the embodiments may be used with any type of imaging device. In operation of the imaging device 700, i.e., light capture, pixel circuitry comprising photosensors in each row of the imaging sensor 712 are all turned on at the same time by a row select line, and the signals of the photosensors and anti-fuse element of each column of the imaging sensor 712 are selectively output onto output lines by respective column select lines. A plurality of row and column select lines are provided for the entire imaging sensor 712. The row lines are selectively activated in sequence by the row driver 710 in response to row address decoder 720 and the column select lines are selectively activated in sequence for each row activation by the column driver 760 in response to column address decoder 770. Thus, row and column addresses are provided for each pixel circuit comprising a photosensor and each circuit comprising an anti-fuse element of the imaging sensor 712. The imaging device 700 is operated by the control circuit 750, which controls address decoders 720, 770 for selecting the appropriate row and column select lines for pixel readout, and row and column driver circuitry 710, 760, which apply driving voltage to the drive transistors of the selected row and column lines.

In a CMOS imaging device, the pixel output signals typically include a pixel reset signal Vrst taken off of the floating diffusion region (via a source follower transistor) when it is reset and a pixel image signal Vsig, which is taken off the floating diffusion region (via a source follower transistor) after charges generated by an image are transferred to it. The Vrst and Vsig signals are read by a sample and hold circuit 761 and are subtracted by a differential amplifier 762 that produces a difference signal (Vrst−Vsig) for each photosensor of the imaging sensor 712, which represents the amount of light impinging on the photosensor of the imaging sensor 712. This signal difference is digitized by an analog-to-digital converter (ADC) 775. The digitized pixel signals are then fed to an image processor 780 which processes the pixel signals and form a digital image output. In addition, as depicted in FIG. 12, the imaging device 700 is formed on a single semiconductor chip.

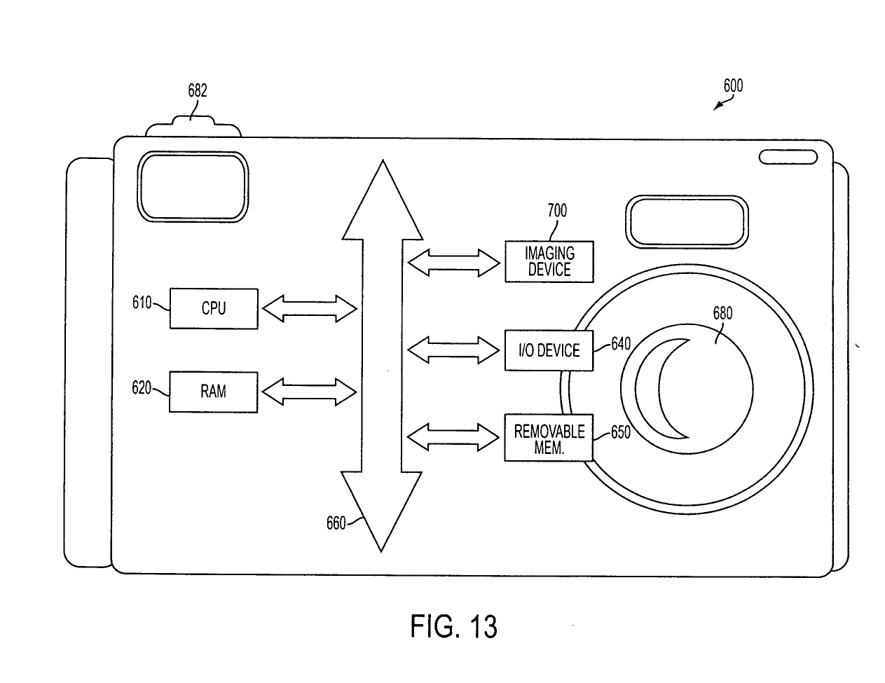

FIG. 13 shows a typical system 600, such as, for example, a camera. The system 600 is an example of a system having digital circuits that could include imaging devices 700. Without being limiting, such a system could include a computer system, camera system, scanner, machine vision, vehicle navigation system, video phone, surveillance system, auto focus system, star tracker system, motion detection system, image stabilization system, and other systems employing an imaging device 700.

System 600, for example, a camera system, includes a lens 680 for focusing an image on the imaging device 700 when a shutter release button 682 is pressed. System 600 generally comprises a central processing unit (CPU) 610, such as a microprocessor that controls camera functions and image flow, and communicates with an input/output (I/O) device 640 over a bus 660. The imaging device 700 also communicates with the CPU 610 over the bus 660. The processor-based system 600 also includes random access memory (RAM) 620, and can include removable memory 650, such as flash memory, which also communicates with the CPU 610 over the bus 660. The imaging device 700 may be combined with the CPU 610, with or without memory storage on a single integrated circuit or on a different chip than the CPU 610.

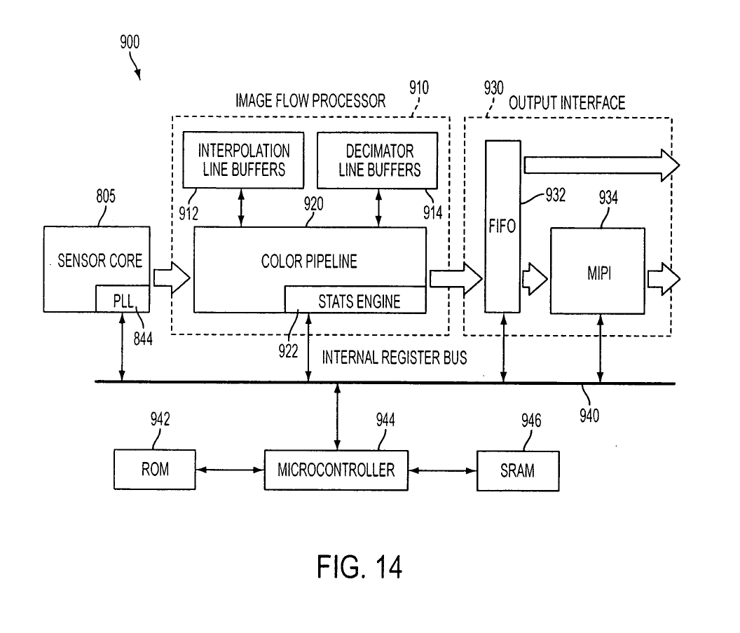

FIG. 14 illustrates a block diagram of system-on-a-chip (SOC) imaging device 900 constructed in accordance with an embodiment. The imaging device 900 comprises a sensor core 805 that communicates with an image flow processor 910 that is also connected to an output interface 930. A phase locked loop (PLL) 844 is used as a clock for the sensor core 805. The image flow processor 910, which is responsible for image and color processing, includes interpolation line buffers 912, decimator line buffers 914 and a color pipeline 920. The color pipeline 920 includes, among other things, a statistics engine 922. The output interface 930 includes an output first-in-first-out (FIFO) parallel output 932 and a serial Mobile Industry Processing Interface (MIPI) output 934. The user can select either a serial output or a parallel output by setting registers within the chip. An internal register bus 940 connects read only memory (ROM) 942, a microcontroller 944 and a static random access memory (SRAM) 946 to the sensor core 805, image flow processor 910 and the output interface 930.

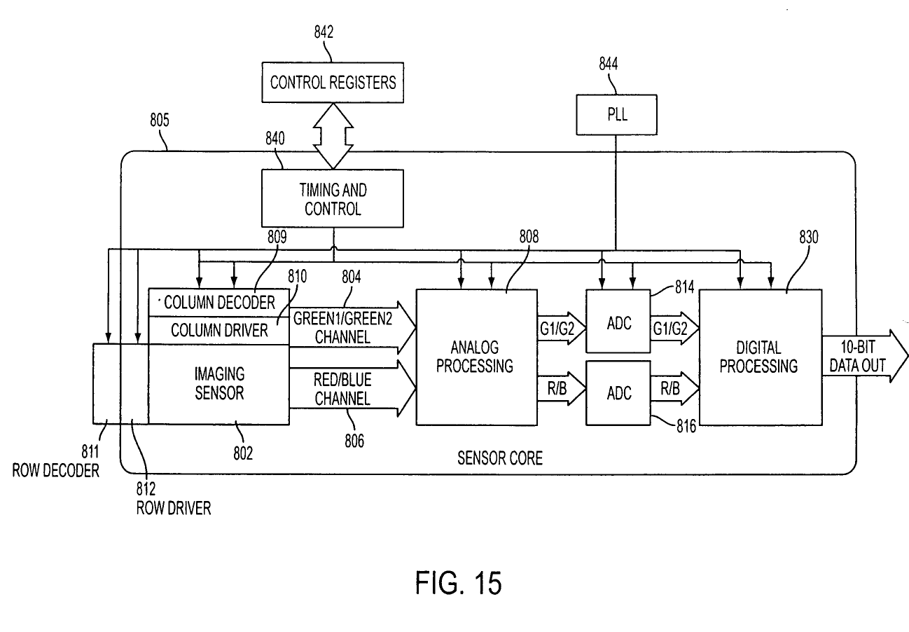

FIG. 15 illustrates a sensor core 805 used in the FIG. 14 imaging device 900. The sensor core 805 includes an imaging sensor 802, which is connected to analog processing circuitry 808 by a greenred/greenblue channel 804 and a red/blue channel 806. Although only two channels 804, 806 are illustrated, there are effectively two green channels, one red channel, and one blue channel, for a total of four channels. The greenred (i.e., Green1) and greenblue (i.e., Green2) signals are readout at different times (using channel 804) and the red and blue signals are readout at different times (using channel 806). The analog processing circuitry 808 outputs processed greenred/greenblue signals G1/G2 to a first analog-to-digital converter (ADC) 814 and processed red/blue signals R/B to a second analog-to-digital converter 816. The outputs of the two analog-to-digital converters 814, 816 are sent to a digital processor 830.

Connected to, or as part of, the imaging sensor 802 are row and column decoders 811, 809 and row and column driver circuitry 812, 810 that are controlled by a timing and control circuit 840. The timing and control circuit 840 uses control registers 842 to determine how the imaging sensor 802 and other components are controlled. As set forth above, the PLL 844 serves as a clock for the components in the core 805.

The imaging sensor 802 comprises a plurality of pixel circuits arranged in a predetermined number of columns and rows. In operation, the pixel circuits of each row in imaging sensor 802 are all turned on at the same time by a row select line and the pixel circuits of each column are selectively output onto column output lines by a column select line. A plurality of row and column lines are provided for the entire imaging sensor 802. The row lines are selectively activated by row driver circuitry 812 in response to the row address decoder 811 and the column select lines are selectively activated by a column driver 810 in response to the column address decoder 809. Thus, a row and column address is provided for each pixel circuit. The timing and control circuit 840 controls the address decoders 811, 809 for selecting the appropriate row and column lines for pixel readout, and the row and column driver circuitry 812, 810, which apply driving voltage to the drive transistors of the selected row and column lines.

Each column contains sampling capacitors and switches in the analog processing circuit 808 that read a pixel reset signal Vrst and a pixel image signal Vsig for selected pixel circuits. Because the core 805 uses greenred/greenblue channel 804 and a separate red/blue channel 806, circuitry 808 will have the capacity to store Vrst and Vsig signals for greenred/greenblue and red/blue pixel signals. A differential signal (Vrst−Vsig) is produced by differential amplifiers contained in the circuitry 808 for each pixel. Thus, the signals G1/G2 and R/B are differential signals that are then digitized by a respective analog-to-digital converter 814, 816. The analog-to-digital converters 814, 816 supply digitized G1/G2, R/B pixel signals to the digital processor 830, which forms a digital image output (e.g., a 10-bit digital output). The output is sent to the image flow processor 910 (FIG. 14).

Although the sensor core 805 has been described with reference to use with a CMOS imaging sensor, this is merely one example sensor core that may be used. Embodiments of the invention may also be used with other sensor cores having a different readout architecture. For example, a CCD (Charge Coupled Device) core could also be used, which supplies pixel signals for processing to an image flow signal processor 910 (FIG. 14).

Some of the advantages of the quantum efficiency measurement method disclosed herein include allowing a quantum efficiency spectrum measurement for imaging devices on the wafer level at a much lower cost than current quantum efficiency spectrum measurement systems. Additionally, the disclosed quantum efficiency measurement method is suitable for quantum efficiency spectrum measurement of imaging sensors with either shifted microlens or non-shifted microlens. The disclosed quantum efficiency measurement method is a valuable tool for new color filter array/microlens process optimization and for quantum efficiency spectrum trend checks in imaging device probe tests.

The new imaging sensor design 65, shown in FIG. 9A, will allow wafer level quantum efficiency spectrum measurement on a part-by-part basis. The resulting quantum efficiency spectrum is not affected by an imaging devices's microlens shift required for normal imaging purpose. Further, the new imaging sensor design allows wafer level adjusting of a imaging device's color pipeline parameters and provides a means to save the adjusted parameters on the on-chip anti-fuse memory cells. These advantages will save significant money and time on module/camera calibration.

While the embodiments have been described in detail in connection with preferred embodiments known at the time, it should be readily understood that the invention is not limited to the disclosed embodiments. Rather, the embodiments can be modified to incorporate any number of variations, alterations, substitutions, or equivalent arrangements not heretofore described. For example, while the embodiments are described in connection with a CMOS imaging sensor, they can be practiced with any other type of imaging sensor (e.g., CCD, etc.). Additionally, three or five channels, or any number of channels may be used, rather than four, for example, and they may comprise additional or different colors/channels than greenred, red, blue, and greenblue, such as e.g., cyan, magenta, yellow (CMY); cyan, magenta, yellow, black (CMYK); or red, green, blue, indigo (RGBI).

What is claimed as new and desired to be protected by Letters Patent of the United States is:

1. A method of performing a quantum efficiency spectrum measurement on an imaging sensor having an array of color pixels arranged in rows and columns, said method comprising:
selecting a subset of columns and rows from the array of color pixels;
projecting spatially separated monochromatic light having a spectral range and a width on the selected subset, the light being projected so that at least a portion of a spectral range of the spatially separated monochromatic light is projected along the width of the selected columns and the length of the selected rows;
determining the wavelength points of the monochromatic light to be measured; and
calculating the quantum efficiency at each determined wavelength point for each pixel residing in the selected subset.

2. The method of claim 1, wherein the step of projecting spatially separated monochromatic light on the selected subset comprises focusing the projected spatially separated monochromatic light onto the selected subset via an optical system.

3. The method of claim 1, wherein the step of projecting spatially separated monochromatic light on the selected subset comprises filtering broadband light with a wedge filter.

4. The method of claim 1, wherein the step of projecting spatially separated monochromatic light on the selected subset comprises filtering broadband light with a diffractive grating filter.

5. The method of claim 1, wherein the step of projecting spatially separated monochromatic light on the selected subset comprises filtering broadband light with a prism.

6. The method of claim 1, further comprising storing data representing the result of the calculated quantum efficiency spectrum measurement in a memory.

7. The method of claim 6, wherein said memory is an anti-fuse memory.

8. The method of claim 7, wherein said anti-fuse memory comprises memory cells which are contiguous to parts of said pixel array.

9. The method of claim 1, further comprising:
determining that a width of the projected spatially separated monochromatic light is larger than the width of the selected subset;
determining that wavelength points along the width of the spectral range of the spatially separated monochromatic light have not been calculated;
projecting the spatially separated monochromatic light on the selected subset, the light being projected so that a portion of the wavelength points of the spatially separated monochromatic light that have not been calculated is projected along the width of the selected columns and the length of the selected rows;
calculating the quantum efficiency at each determined wavelength point for each pixel residing in the selected subset that has not previously been calculated; and repeating the projecting and calculating steps until all determined wavelength points of the spatially separated monochromatic light have been measured.

10. The method of claim 1, wherein the act of calculating the quantum efficiency at each determined wavelength point for each pixel residing in the selected subset comprises determining the quantum efficiency for a determined wavelength point comprising the steps of:
determining the width of the wavelength being calculated;
calculating the number of rows covered by the wavelength being calculated by dividing the width of the wavelength by the pitch of the pixels of the selected subset;
calculating the total number of pixels covered by the wavelength by multiplying the calculated number of rows and the number of columns of the selected subset;
calculating the number of pixels of a color channel of the selected subset by dividing the calculated total number of pixels by the number of color channels within the selected subset;
calculating the mean signal for a number of frames n of image data;
calculating the mean temporal noise for the color pixels inside the selected subset;
calculating the total electrons generated for a specific color pixel; and
calculating the quantum efficiency at the determined wavelength point.

11. The method of claim 1, wherein the act of calculating the quantum efficiency at each determined wavelength point for each pixel residing in the selected subset comprises determining the quantum efficiency for a determined wavelength point comprising the steps of:
determining the width of the wavelength being calculated;
calculating the number of rows covered by the wavelength being calculated by dividing the width of the wavelength by the pitch of the pixels of the selected subset;
calculating the total number of pixels covered by the wavelength by multiplying the calculated number of rows and the number of columns of the selected subset;
calculating the number of pixels of a color channel of the selected subset XY by dividing the calculated total number of pixels by the number of color channels within the selected subset;
calculating the mean signal for a number of frames n of image data according to:
$$S = \frac{1}{XYN} {\sum }_{n = 1}^{N} {\sum }_{x = 0}^{X - 1} {\sum }_{y = 0}^{Y - 1} {p}_{n} ( x , y )$$
where N is the number of frames of image data, XY is the calculated number of pixels of a color channel, n, x, and y are integer indexes covering the range:
1≦n≦N;0≦x≦(X−1);0≦y≦(Y−1)
and pₙ (x, y) represents the pixel signal of location (x,y) of the nth frame;
calculating the mean temporal noise for the color pixels inside the selected subset according to:
$${n}_{temp} = {[ \frac{1}{XYN} {\sum }_{n = 1}^{N} {\sum }_{x = 0}^{X - 1} {\sum }_{y = 0}^{Y - 1} {( {p}_{n} ( x , y ) - \overline{p} ( x , y ) )}^{2} ]}^{1 / 2}$$
where the partial signal average (average over frames) for a pixel at location (x,y) can be expressed as:
$$\overline{p} ( x , y ) = \frac{1}{N} {\sum }_{n = 1}^{N} {p}_{n} ( x , y ) ;$$
calculating the total electrons generated for a specific color pixel according to:
Nₑ=(S/nₜₑₘₚ)²
where S is the calculated mean signal and nₜₑₘₚ is the calculated mean temporal noise for the color pixels inside the selected subset; and
calculating the quantum efficiency at the determined wavelength point according to:
$$η = \frac{{N}_{e}}{{n}_{photon} \cdot {d}^{2} \cdot {t}_{int}}$$
where nₚₕₒₜₒₙ is a known photon density, d is the pixel pitch, and tint is the pixel integration time.

12. An imaging sensor comprising:
an array of active pixels with shifted microlenses wherein the active pixels with shifted microlenses are configured for active imaging and
an array of active pixels with no microlens shift wherein the active pixels with no microlens shift are configured for calibration.

13. The imaging sensor of claim 12, further comprising optical black pixels, wherein the optical black pixels are configured for black level calibration, dark current compensation, and row noise correction.

14. The imaging sensor of claim 12, further comprising pixels in which the photodiode is tied to a fixed voltage, wherein the pixels in which the photodiode is tied to a fixed voltage are configured for black level calibration, dark current compensation, and row noise correction.

15. The imaging sensor of claim 13, further comprising barrier pixels adjacent to the active pixel array, wherein the barrier pixels are configured to reduce interference between the optical black pixels and the active pixel array.

16. The imaging sensor of claim 12, further comprising an array of anti-fuse memory cells wherein the anti-fuse memory cells are configured for storing data representing a quantum efficiency spectrum measurement.

17. A test system comprising:
a source of a broadband light;
a device for spatially separating the broadband light; and
a region for testing an imaging device.

18. The test system of claim 17, wherein the device for spatially separating the broadband light comprises a wedge filter.

19. The test system of claim 17, wherein the device for spatially separating the broadband light comprises a diffractive grating filter.

20. The test system of claim 17, wherein the device for spatially separating the broadband light comprises a prism.

21. The test system of claim 17, further comprising an imaging device having a selected subset of columns and rows of pixels from an imaging sensor having an array of color pixels arranged in rows and columns illuminated by the spatially separated broadband light.

22. The test system of claim 21, wherein the selected subset comprises pixels with no microlens shift.

23. The test system of claim 21, wherein the imaging sensor has a small maximum chief ray angle.

24. The test system of claim 21, wherein the imaging sensor has a large maximum chief ray angle.

25. The test system of claim 17, further comprising a probe for testing the imaging device.

26. The test system of claim 25, further comprising a processor for processing the results from the probe.

27. The test system of claim 17, further comprising an imaging device having a selected subset selected from an array of calibration pixels of an imaging sensor illuminated by the spatially separated broadband light.

28. The test system of claim 17, further comprising a continuous variable neutral density filter for testing an imaging device.

29. An imaging device comprising:
an imaging sensor having an array of active pixels with no microlens shift wherein the active pixels with no microlens shift are configured for calibration and
a device for storing data representing the calibration results.

30. A digital camera comprising:
an imaging device comprising:
an imaging sensor having an array of active pixels with no microlens shift wherein the active pixels with no microlens shift are configured for calibration and
a device for storing data representing the calibration results.
